(19) United States
(12) Patent Application Publication
(10) Pub. No.: US 2024/0429485 A1
(43) Pub. Date: Dec. 26, 2024

(54) BATTERY PACK

(71) Applicants: Hyundal Motor Company, Seoul (KR); Kia Corporation, Seoul (KR)

(72) Inventors: Hyunchang Kang, Seoul (KR); Junyoung Kang, Hwaseong-si (KR); JeongHun Seo, Suwon-si (KR); Jiwoong Jung, Anyang-si (KR)

(21) Appl. No.: 18/515,623

(22) Filed: Nov. 21, 2023

(30) Foreign Application Priority Data
Jun. 20, 2023 (KR) 10-2023-0079005

(51) Int. Cl. H01M 10/6554; H01M 10/613; H01M 10/647; H01M 10/659; H01M 50/178; H01M 50/211; H01M 50/507

(52) U.S. Cl. CPC H01M 10/6554; H01M 10/613; H01M 10/647; H01M 10/659; H01M 50/178; H01M 50/211; H01M 50/507

(57) ABSTRACT

An embodiment battery pack includes a battery module including a battery cell stack in which a plurality of battery cells are stacked in a predetermined direction, upper and lower cooling apparatuses disposed in upper and lower portions of the battery module, respectively, the upper and lower cooling apparatuses being configured to cool heat generated from the battery module, an upper cooling plate disposed between the battery module and the upper cooling apparatus, a lower cooling plate disposed between the battery module and the lower cooling apparatus, an upper gap filler filling a space between the battery cell stack and the upper cooling plate, and a lower gap filler filling a space between the battery cell stack and the lower cooling plate, wherein the upper and lower gap fillers each include a phase-change material.

### CROSS-REFERENCE TO RELATED APPLICATIONS

This application claims the benefit of Korean Patent Application No. 10-2023-0079005, filed on Jun. 20, 2023, which application is hereby incorporated herein by reference.

### TECHNICAL FIELD

The present disclosure relates to a battery pack.

### BACKGROUND

Secondary batteries having high application easiness according to products and electrical characteristics of high energy density are widely used in electric vehicles, hybrid vehicles, and the like driven by electric driving sources, as well as portable devices. These secondary batteries are attracting attention as a new energy source for improving eco-friendliness and energy efficiency in that the secondary batteries do not generate any by-products due to the use of energy as well as the primary advantage of dramatically reducing the use of fossil fuels.

The secondary batteries that are currently widely used include lithium ion batteries, lithium polymer batteries, nickel cadmium batteries, nickel hydrogen batteries, nickel zinc batteries, and the like. An operating voltage of a unit secondary battery cell, that is, a unit battery cell, is about 2.5 V to 4.6 V. Accordingly, when a higher output voltage than the operating voltage is required, a plurality of battery cells is connected in series to form a battery pack. In addition, a plurality of battery cells may be connected in parallel to form a battery pack according to the charge/discharge capacity required for the battery pack. Accordingly, the number of battery cells included in the battery pack may be variously set according to a required output voltage or charge/discharge capacity.

On the other hand, when a battery pack is configured by connecting a plurality of battery cells in series/parallel, a method of configuring a first battery module including at least one battery cell and then configuring a battery pack by adding other components using such at least one battery module is common.

Since a battery pack having a multi-module structure is manufactured in a form in which a plurality of secondary batteries is concentrated in a narrow space, it is important to easily discharge heat generated from each secondary battery. Since the charging or discharging process of the secondary battery is implemented by an electrochemical reaction, when the heat of the battery module generated during the charging/discharging process is not effectively removed, heat accumulation occurs, and as a result, deterioration of the battery module is accelerated, and in some cases, ignition or an explosion may occur.

Therefore, a high-output and large-capacity battery module and a battery pack equipped with the high-output and large-capacity battery module must necessarily have a cooling device for cooling the battery cells equipped therein.

A battery module in the related art generally adopts a cooling structure that emits heat by contacting a thermal interface material (TIM) between battery cells and a heat sink for the cooling.

However, in the cooling structure in the related art, there is a problem in that it is difficult to increase the performance of a battery module and a battery pack, and furthermore, the performance of an electric vehicle including the battery modules or the battery pack due to low cooling performance.

The matters described in the description of the related art are prepared to enhance the understanding of the background of embodiments of the disclosure and may include matters that are not already known to those skilled in the art to which the present technology belongs.

### SUMMARY

The present disclosure relates to a battery pack. Particular embodiments relate to a battery pack capable of efficiently cooling and discharging heat generated from a battery cell.

Embodiments of the present disclosure provide a battery pack capable of dissipating and cooling heat generated in the battery cell.

A battery pack may include a battery module including a battery cell stack in which a plurality of a battery cells are stacked in a predetermined direction, upper and lower cooling apparatuses provided in upper and lower portions of the battery module, respectively, and configured to cool heat generated from the battery module, an upper cooling plate provided between the battery module and an upper cooling apparatus, a lower cooling plate provided between the battery module and the lower cooling apparatus, an upper gap filler filling a space formed between the battery cell stack and the upper cooling plate, and a lower gap filler filling a space formed between the battery cell stack and the lower cooling plate, where the upper and lower gap fillers may include a phase-change material.

A battery pack may further include front and rear busbar housings provided in front and rear sides of the battery cell stack, respectively, and configured to electrically connect a plurality of battery cells, front and rear sensing covers configured to cover the busbar housing, and a front gap filler and a front-and-rear gap filler filling a space between the front and rear busbar housings and the front and rear sensing covers, where the front gap filler and the front-and-rear gap filler may include the phase-change material.

A lower end portion of a front sensing board provided between the front busbar housing and the battery cell may extend toward the front sensing cover to insulate between a busbar frame and the lower cooling plate.

The lower gap filler may extend to an inner side surface of the front sensing cover, and a lower end portion of the busbar frame may be immersed in the lower gap filler.

A rib for reinforcing the strength of the sensing covers may be formed in a lattice shape on inner side surfaces of the front sensing cover and the rear sensing cover, and the lattice shaped rib may be filled with the front gap filler containing the phase-change material.

The front gap filler in a sheet form containing the phase-change material may be attached to inner side surfaces of the front sensing cover and the rear sensing cover.

A battery pack may further include a left side end plate and a right side end plate configured to support both sides of a plurality of battery cells, respectively, where a height of the end plate is formed to be lower than a height of the battery cell.

A compression pad may be provided between adjacent battery cells of a plurality of battery cells, and the compression pad may include the phase-change material.

The phase-change material may be coated on both side surfaces of the compression pad in contact with the battery cell.

The battery cell may include a battery case configured to accommodate an electrode assembly, a cell terrace extending from the battery case and configured to seal the electrode assembly, and an electrode lead partially protruding from the cell terrace, where a gap filler containing the phase-change material is applied to the cell terrace.

According to the battery pack according to an embodiment as described above, by providing a gap filler containing a phase-change material around each part constituting the battery module of the battery pack, respective component parts may be rapidly cooled using the latent heat of the phase-change material.

Other effects that may be obtained or are predicted by an embodiment will be explicitly or implicitly described in a detailed description of the embodiments of the present disclosure. That is, various effects that are predicted according to an exemplary embodiment will be described in the following detailed description.

### BRIEF DESCRIPTION OF THE DRAWINGS

These drawings are for reference in describing exemplary embodiments of the present disclosure, and the technical spirit of the embodiments of the present disclosure should not be construed as being limited to the accompanying drawings.

FIG. 1 is an exploded perspective view showing a configuration of a battery pack according to an embodiment.

FIG. 2 is a schematic view showing a configuration of a battery pack according to an embodiment.

FIG. 3 is a perspective view showing a configuration of a battery module according to an embodiment.

FIG. 4 is an exploded perspective view of a battery module according to an embodiment.

FIG. 5 is a partial cross-sectional view taken along line A-A of FIG. 3.

FIG. 6 is a schematic view showing a configuration of a plurality of battery cells and an end plate according to an embodiment.

FIG. 7 is a perspective view showing a configuration of a sensing cover according to an embodiment.

FIG. 8 is a cross-sectional view taken along line B-B of FIG. 7.

FIG. 9 is a cross-sectional view taken along line C-C of FIG. 7.

FIG. 10 is a perspective view showing a configuration of a battery cell according to an embodiment.

FIG. 11A and FIG. 11B are schematic views showing a configuration of adjacent battery cells according to an embodiment.

FIG. 12A and FIG. 12B are graphs showing effects of a battery pack according to an embodiment.

It should be understood that the above-referenced drawings are not necessarily to scale, presenting a somewhat simplified representation of various preferred features illustrative of the basic principles of embodiments of the disclosure. The specific design features of embodiments of the present disclosure, including, for example, specific dimensions, orientations, locations, and shapes, will be determined in part by the particular intended application and use environment.

### DETAILED DESCRIPTION OF ILLUSTRATIVE EMBODIMENTS

The terminology used herein is for the purpose of describing particular embodiments only and is not intended to be limiting of the embodiments of the present invention. As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any one or all combinations of one or more related items.

Embodiments of the present disclosure will be described more fully hereinafter with reference to the accompanying drawings, in which exemplary embodiments of the disclosure are illustrated. As those skilled in the art would realize, the described embodiments may be modified in various different ways, all without departing from the spirit or scope of the embodiments of the present disclosure.

The drawings and description are to be regarded as illustrative in nature and not restrictive, and like reference numerals designate like elements throughout the specification.

In addition, the size and thickness of each configuration shown in the drawings are arbitrarily shown for understanding and ease of description, but the embodiments of the present disclosure are not limited thereto, and the thickness of layers, films, panels, regions, etc. are exaggerated for clarity.

Suffixes such as “module” and/or “unit” for a constituent element used for the description below are given or mixed in consideration of only easiness of the writing of the specification, and the suffix itself does not have a discriminated meaning or role.

Further, in describing the exemplary embodiments disclosed in the present disclosure, when it is determined that the detailed description relating to well-known functions or configurations may make the subject matter of the exemplary embodiments disclosed in the present disclosure unnecessarily ambiguous, the detailed description will be omitted.

Further, the accompanying drawings are provided for helping to easily understand exemplary embodiments disclosed in the present specification, and the technical spirit disclosed in the embodiments of the present specification is not limited by the accompanying drawings, and it will be appreciated that the embodiments of the present disclosure include all of the modifications, equivalent matters, and substitutes included in the spirit and the technical scope of the embodiments of the present disclosure.

Terms including an ordinary number, such as first and second, are used for describing various constituent elements, but the constituent elements are not limited by the terms.

In the description below, expressions described in the singular form may be construed in the singular or plural unless an explicit expression such as “one” or “single” is used.

The terms are used only to discriminate one constituent element from another constituent element.

Hereinafter, a battery pack 1 according to an embodiment will be described in detail with reference to the drawings.

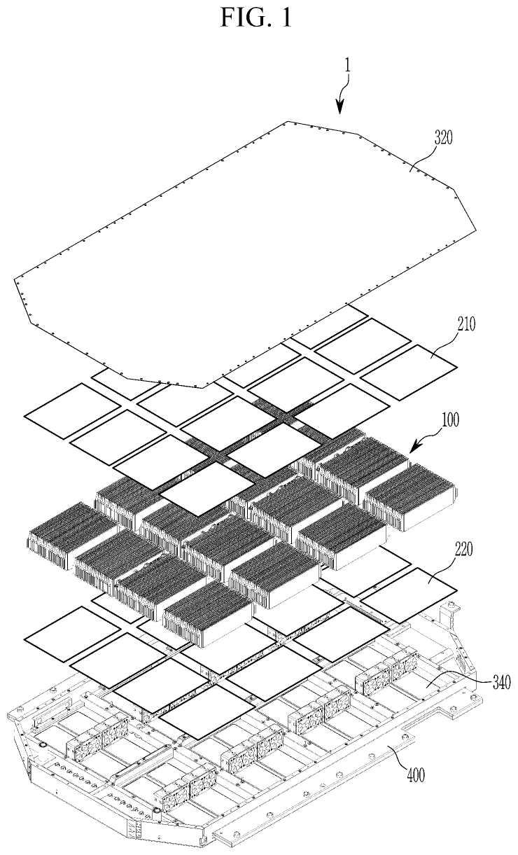

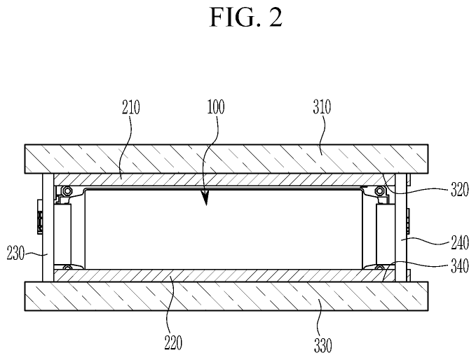

FIG. 1 is an exploded perspective view showing a configuration of a battery pack according to an embodiment. In addition, FIG. 2 is a schematic view showing a configuration of a battery pack according to an embodiment.

As shown in FIG. 1 and FIG. 2, the battery pack 1 according to an embodiment may include a battery module 100 including a plurality of battery cells 110, a cooling apparatus, and a housing 400 accommodating a plurality of the battery modules 100 and the cooling apparatus.

In embodiments of the present disclosure, a direction in which the battery cell 110 of the battery module 100 is stacked is referred to as a left-and-right direction (alternatively, an X-direction or a width direction), a direction in which the battery cell 110 extends is referred to a front-and-rear direction (alternatively, a Y-direction or a length direction), and a direction perpendicular to the left-and-right direction and the front-and-rear direction is referred to as a vertical direction (alternatively, a Z-direction or a height direction).

The plurality of battery cells 110 may constitute the battery module 100, and the plurality of battery modules 100 may constitute the battery pack 1.

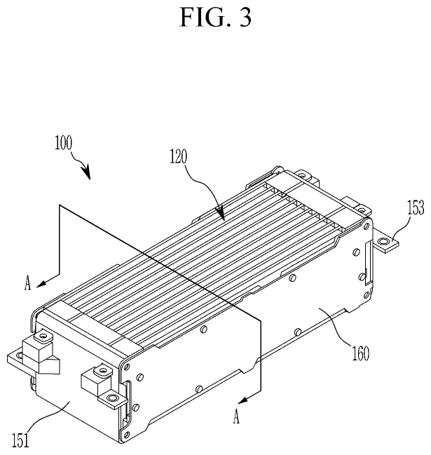

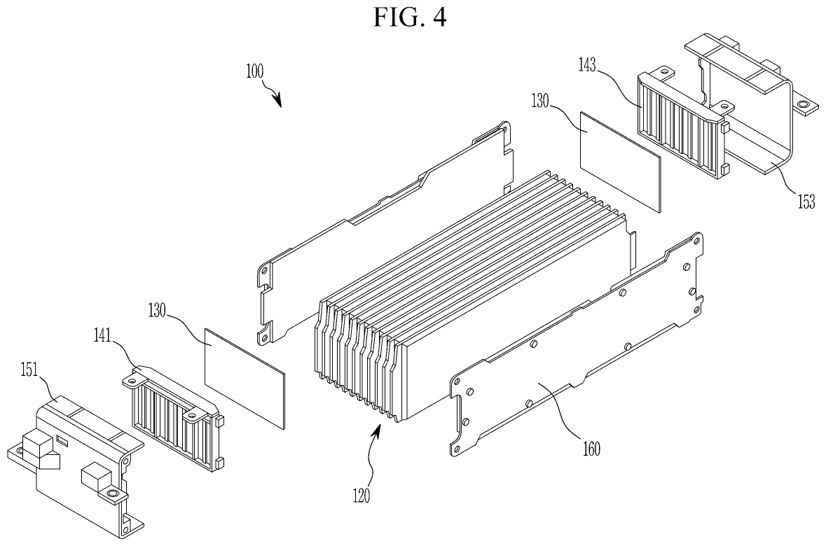

Referring to FIG. 3 to FIG. 5, the plurality of battery cells 110 constituting the battery module 100 are stacked in a predetermined direction (for example, the left-and-right direction or the X-direction), and the plurality of battery cells 110 may be connected in parallel and/or in series. Each of the battery cells 110 constituting the battery module 100 is a secondary battery and may be a pouch-type secondary battery. The plurality of battery cells 110 may form a battery cell stack 120 by being stacked to be electrically interconnected.

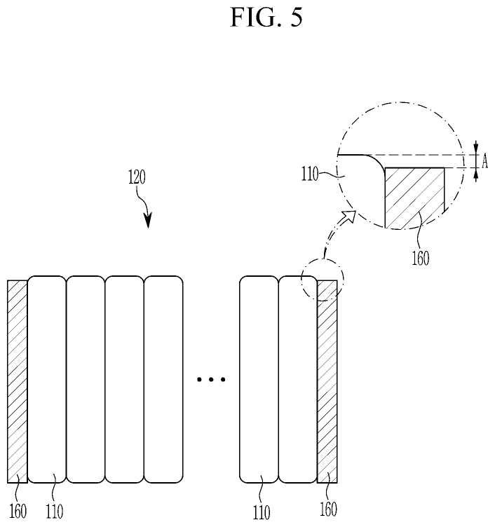

A sensing board 130, a busbar frame 140, and a sensing cover 150 are disposed in both sides of the battery cell stack 120 in the front-and-rear direction. In addition, a left end plate 160 and a right end plate 160 are provided in both sides of the battery cell stack 120, respectively, and the left and right end plates 160 support the plurality of battery cells 110. At this time, a height of the left end plate 160 and the right end plate 160 supporting the battery cell stack 120 at both sides in the left-and-right direction may be formed lower than a height of the battery cell 110 (refer to FIG. 5). For example, the height of the left end plate 160 and the right end plate 160 may be designed to be lower than the height of the battery cell 110 by about 1 mm or less.

The busbar frame 140 is disposed between the sensing board 130 and the sensing cover 150 and electrically connects electrode leads 113 of the battery cells 110, such that the plurality of battery cells 110 may be connected in series and/or in parallel.

The sensing board 130 is provided in an outer side of the battery cell stack 120 in the front-and-rear direction and may transmit state information including voltage, current, and temperature of the battery cell 110 to a battery management system (BMS) (not shown). The sensing board 130 may be implemented as a printed circuit board (PCB).

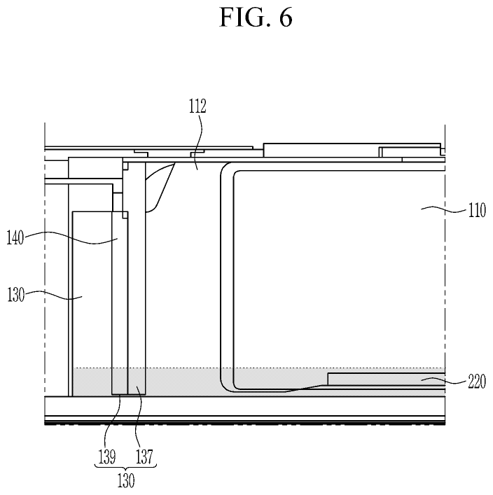

The sensing board 130 may include a board body 137 having an area corresponding to an area of the plurality of battery cells 110 in the X-Z direction and a board extension portion 139 extending from a lower portion of the board body 137 toward the busbar frame 140. The busbar frame 140 of a metal material and a lower cooling plate 340 of a metal material may be insulated by the board extension portion 139 (refer to FIG. 6).

A front sensing cover 151 is disposed in a front side (+the Y-direction) of the battery cell stack 120, a rear sensing cover 153 is disposed in a rear side (−the Y-direction) of the battery cell stack 120, and the front sensing cover 151 and the rear sensing cover 153 are configured to cover the front side and the rear side of the battery cell stack 120.

That is, the front sensing cover 151, a front busbar frame 141, a front sensing board 131, the battery cell stack 120, a rear sensing board 133, a rear busbar frame 143, and the rear sensing cover 153 are sequentially disposed along the front-and-rear direction of the battery module 100.

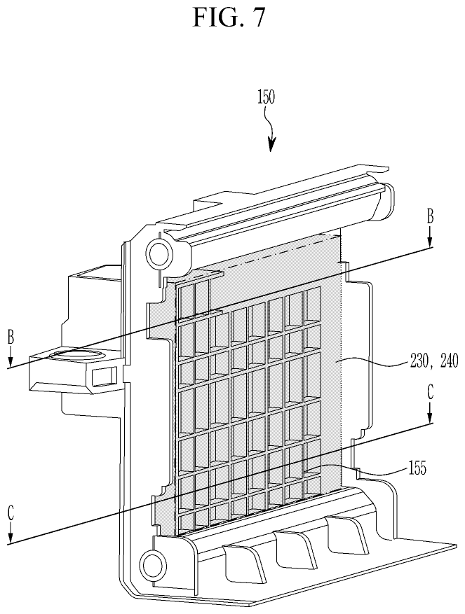

Referring to FIG. 7 to FIG. 9, the front sensing cover 151 and the rear sensing cover 153 cover front and rear end portions of the battery cell stack 120, respectively, the front sensing cover 151 and the rear sensing cover 153 are made of a plastic material, and a plurality of ribs 155 may be formed in a lattice shape in inner sides of the front sensing cover 151 and the rear sensing cover 153 in order to reinforce strength.

In embodiments of the present disclosure, the front sensing cover 151 and the rear sensing cover 153 are disposed to face each other and may have shapes symmetrical to each other.

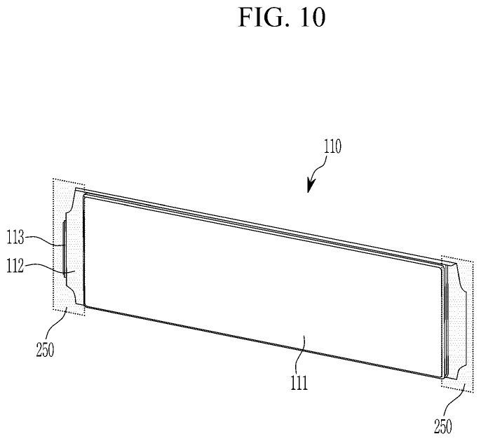

Referring to FIG. 10, the battery cell 110 may include a battery case 111 configured to accommodate an electrode assembly including a positive electrode plate, a negative electrode plate, and a separator, a cell terrace 112 extending from the battery case 111 and configured to seal the electrode assembly, and the electrode lead 113 partially protruding from the cell terrace 112.

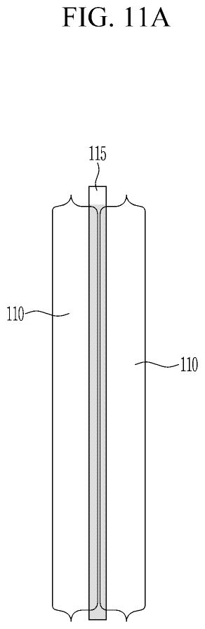

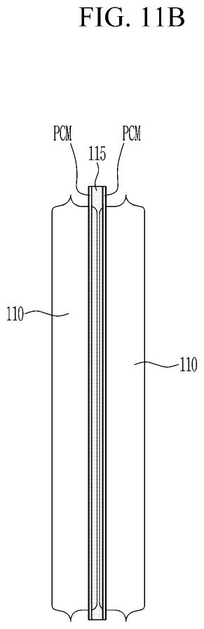

Referring to FIG. 11A and FIG. 11B, a compression pad 115 is provided between adjacent battery cells 110. The compression pad 115 may be manufactured using a polyurethane material. The compression pad 115 may absorb thickness deformation of the battery cell 110 due to swelling and deformation of the battery cell 110 due to external impact.

Referring back to FIG. 1 and FIG. 2, the cooling apparatus cools the heat generated from the battery module 100 and may include an upper cooling apparatus 310 disposed in an upper portion of the battery module 100 and a lower cooling apparatus 330 disposed in a lower portion of the battery module 100. An upper cooling plate 320 is disposed between the battery module 100 and the upper cooling apparatus 310, and the lower cooling plate 340 is disposed between the battery module 100 and the lower cooling apparatus 330.

Accordingly, the heat generated from the battery cell 110 and the battery module 100 is transferred to upper and lower cooling apparatuses 310 and 330 through upper and lower cooling plates 320 and 340, and the heat transferred to the upper and lower cooling apparatuses 310 and 330 is cooled through heat-exchange with the coolant flowing through the cooling apparatus.

Hereinafter, a gap filler containing a phase-change material for improving cooling performance of the battery pack 1 according to an embodiment and the battery module 100 will be described in detail.

Referring to FIG. 1 and FIG. 2, an upper gap filler 210 is provided in a space between the upper portion of the battery module 100 and the upper cooling plate 320, and a lower gap filler 220 is provided in a space between the lower portion of the battery module 100 and the lower cooling plate 340.

The upper and lower gap fillers 210 and 220 may be made of silicon or urethane. At this time, the upper and lower gap fillers 210 and 220 may contain the phase-change material (PCM).

The upper gap filler 210 and the lower gap filler 220 may be applied to the upper portion and lower portion of the battery module 100, in the form of a paste, and if necessary, may be attached to the upper portion and the lower portion of the battery module 100 in the form of a sheet.

The upper gap filler 210 fills a space between the upper portion of the battery module 100 and the upper cooling plate 320, the lower gap filler 220 fills a space between the lower portion of the battery module 100 and the lower cooling plate 340, and the upper gap filler 210 and the lower gap filler 220 function to absorb the heat dissipated upwards and downwards of the battery module 100 and to transfer the heat to the upper cooling plate 320 and the lower cooling plate 340.

At this time, since the upper gap filler 210 and the lower gap filler 220 contain the phase-change material, heat generated from the battery cell 110 and the battery module 100 is absorbed to the phase-change material using latent heat of the phase-change material, and an abrupt temperature increase of the battery cell 110 and the battery module 100 may be prevented. In addition, the upper gap filler 210 and the lower gap filler 220 may perform a function to transfer the heat generated from the battery cell 110 and the battery module 100 to the upper cooling plate 320 and the lower cooling plate 340.

Since the upper portion of the battery module 100 is in contact with the upper cooling plate 320 through the upper gap filler 210 and the lower portion of the battery module 100 is in contact with the lower cooling plate 340 through the lower gap filler 220, the heat transfer effect from the battery module 100 to the cooling plate may be maximized.

At this time, as shown in FIG. 5, by forming the height of the end plate 160 lower than the height of the battery cell 110, it is possible to prevent the upper gap filler 210 from being thickly applied, and through this, cooling performance due to the upper gap filler 210 may be prevented from deteriorating.

Referring to FIG. 6, the lower gap filler 220 containing the phase-change material may be formed to extend to an inner side surface of the front sensing cover 151.

The lower gap filler 220 extends to the inner side surface of the front sensing cover 151, and the board extension portion 139 of the sensing board 130 and a lower end portion of the busbar frame 140 may be immersed in the lower gap filler 220. Accordingly, the board extension portion 139 of the sensing board 130 may insulate between the busbar frame 140 and the lower cooling plate 340, and at the same time, cooling performance of the busbar frame 140 may be secured.

Referring to FIG. 2 and FIG. 6 to FIG. 8, a front gap filler 230 may be provided in an inner side of the front sensing cover 151, and a front-and-rear gap filler 240 may be provided in an inner side of the rear sensing cover 153.

The front gap filler 230 and the front-and-rear gap filler 240 may be filled between ribs 155 formed in the inner sides of the front sensing cover 151 and the rear sensing cover 153 in the form of a paste. At this time, a length of the rib 155 formed in the inner sides of the front sensing cover 151 and the rear sensing cover 153 may be formed to be a predetermined length (for example, 5 mm) or more, and thereby the gap filler may be smoothly filled between the ribs 155.

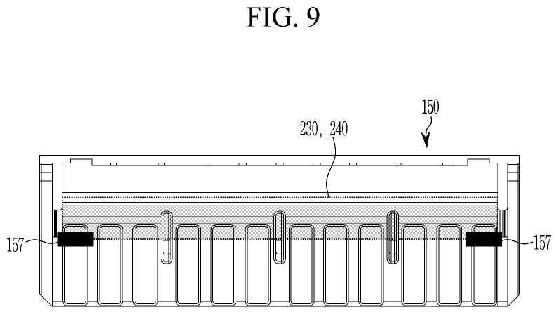

Alternatively, the front gap filler 230 and the front-and-rear gap filler 240 may be attached to the inner sides of the front sensing cover 151 and the rear sensing cover 153 in the form of a sheet (refer to FIG. 9). At this time, a fixing protrusion 157 spaced apart from the inner side surface of the front sensing cover 151 and the inner side surface of the rear sensing cover 153 is formed in the inner side of the front sensing cover 151 and the inner side of the rear sensing cover 153, the front gap filler 230 in the sheet form may be inserted between inner side surfaces of the fixing protrusion 157 and the front sensing cover 151, and the front-and-rear gap filler 240 in the sheet form may be inserted between the inner side surfaces of the fixing protrusion 157 and the rear sensing cover 153.

Since the front gap filler 230 and the front-and-rear gap filler 240 contain the phase-change material, the heat generated from the battery cell 110 and the battery module 100 is absorbed by the phase-change material, and an abrupt temperature increase of the battery cell 110 and the battery module 100 may be prevented.

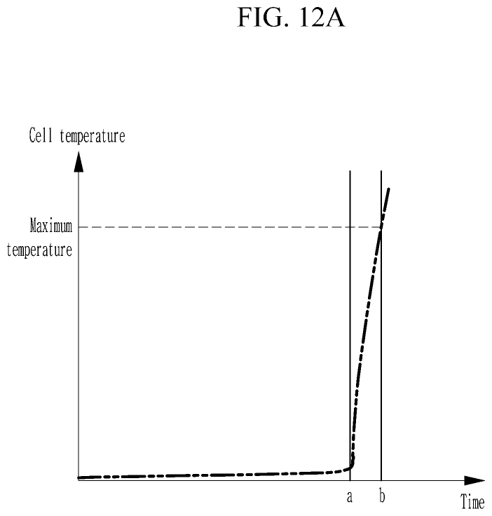

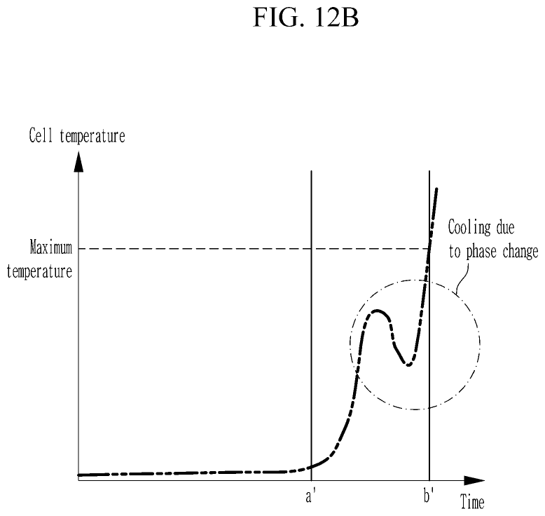

Referring to FIG. 11A and FIG. 11B, the compression pad 115 provided between the battery cells 110 disposed adjacent to each other is formed of a polyurethane (PU) material, and the compression pad 115 may contain the phase-change material (PCM) (refer to FIG. 12A). In embodiments of the present disclosure, the phase-change material may be coated on both sides of the compression pad 115, for example, both side surfaces of the compression pad 115 facing the battery cell 110 (refer to FIG. 12B).

Since the compression pad 115 is made of a material containing the phase-change material, the compression pad 115 may not only absorb thickness deformation of the battery cell 110 due to swelling but may also absorb the heat generated from the battery cell 110 to cool the battery cell 110.

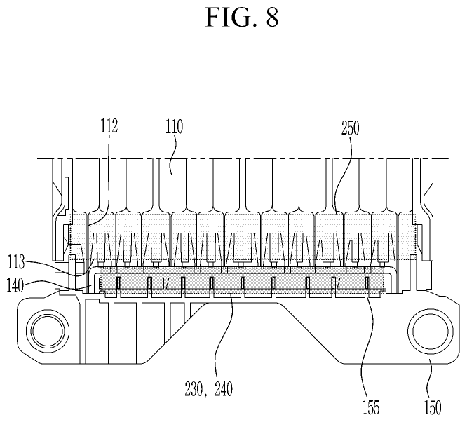

Referring to FIG. 8 and FIG. 10, a terrace gap filler 250 containing the phase-change material may be provided around the cell terrace 112 extending from the battery case 111 of the battery cell 110 and configured to seal the electrode assembly. The terrace gap filler 250 may be applied to the cell terrace 112 in the form of a paste. An area around the cell terrace 112 of the battery cell 110 may be cooled by the terrace gap filler 250 applied to the cell terrace 112.

In embodiments of the present disclosure, the phase-change material contained in the gap fillers may be made of a material having a phase change in a predetermined temperature range (for example, 45 degrees Celsius to 55 degrees Celsius). This is because the cooling effect of the battery cell 110 is maximized, and when the temperature of the battery cell 110 increases to 55 degrees Celsius or more, abnormality may occur in the battery cell 110. In addition, a phase-change material in which a phase change occurs from a solid phase to a liquid phase may be used. In the case of a phase-change material in which a phase change occurs from a solid phase to a gas phase, it is impossible to repeatedly use the phase-change material due to an irreversible reaction.

According to the battery pack 1 according to an embodiment as described above, by providing a gap filler containing a phase-change material around each part constituting the battery module 100 of the battery pack 1, respective component parts may be rapidly cooled using the latent heat of the phase-change material.

High heat is instantaneously generated in the battery cell 110 when thermal runaway occurs in the battery cell 110, and in this case, since a period from a time point a of initiating thermal runaway to a time point b at which the battery cell 110 reaches its maximum temperature is very short, it is very difficult for the occupant such as a driver of the vehicle to cope with the thermal runaway (refer to FIG. 12A).

However, when the battery pack 1 according to an embodiment is applied to a vehicle, when the thermal runaway occurs in the battery cell 110, although heating of the battery cell 110 starts instantaneously, since the respective component parts are rapidly cooled by the phase-change material, the period from a time point a′ of initiating thermal runaway of the battery cell 110 to a time point b′ at which the battery cell 110 reaches its maximum temperature may be increased (refer to FIG. 12B).

Although the exemplary embodiments of the present disclosure have been described, the embodiments of the present disclosure are not limited thereto, and it is possible to carry out various modifications within the scope of the claims, the detailed description of embodiments of the disclosure, and the accompanying drawings, and the modifications belong to the scope of the embodiments of the present disclosure as a matter of course.

The following reference identifiers may be used in connection with the drawings to describe various features of embodiments of the present disclosure.

| | |
|---|---|
| 1: battery pack | 100: battery module |
| 110: battery cell | 111: battery case |
| 112: cell terrace | 113: electrode lead |
| 115: compression pad | 120: battery cell stack |
| 130: sensing board | 131: front sensing board |
| 133: rear sensing board | 137: board body |
| 139: board extension portion | 140: busbar frame |
| 141: front busbar frame | 143: rear busbar frame |
| 150: sensing cover | 151: front sensing cover |
| 153: rear sensing cover | 155: rib |
| 157: fixing protrusion | 160: end plate |
| 210: upper gap filler | 220: lower gap filler |
| 230: front gap filler | 240: front-and-rear gap filler |
| 250: terrace gap filler | 310: upper cooling apparatus |
| 320: upper cooling plate | 330: lower cooling apparatus |
| 340: lower cooling plate | 400: housing |

What is claimed is:

1. A battery pack comprising:
a battery module comprising a battery cell stack in which a plurality of battery cells are stacked in a predetermined direction;
upper and lower cooling apparatuses disposed in upper and lower portions of the battery module, respectively, the upper and lower cooling apparatuses being configured to cool heat generated from the battery module;
an upper cooling plate disposed between the battery module and the upper cooling apparatus;
a lower cooling plate disposed between the battery module and the lower cooling apparatus;
an upper gap filler filling a space between the battery cell stack and the upper cooling plate; and
a lower gap filler filling a space between the battery cell stack and the lower cooling plate, wherein the upper and lower gap fillers each comprise a phase-change material.

2. The battery pack of claim 1, further comprising:
front and rear busbar housings disposed in front and rear sides of the battery cell stack, respectively, the front and rear busbar housings being configured to electrically connect the plurality of battery cells;
front and rear sensing covers configured to cover the front and rear busbar housings, respectively; and
a front gap filler and a front-and-rear gap filler filling a space between the front and rear busbar housings and the front and rear sensing covers, wherein the front gap filler and the front-and-rear gap filler each comprise the phase-change material.

3. The battery pack of claim 2, further comprising a front sensing board disposed between the front busbar housing and the battery cells, wherein a lower end portion of the front sensing board extends toward the front sensing cover to insulate between a busbar frame and the lower cooling plate.

4. The battery pack of claim 3, wherein the lower gap filler extends to an inner side surface of the front sensing cover, and wherein a lower end portion of the busbar frame is immersed in the lower gap filler.

5. The battery pack of claim 2, further comprising ribs disposed in a lattice shape on inner side surfaces of the front sensing cover and the rear sensing cover, the ribs being configured to reinforce a strength of the front and rear sensing covers.

6. The battery pack of claim 5, wherein each of the ribs is filled with the front gap filler comprising the phase-change material.

7. The battery pack of claim 2, wherein the front gap filler is provided in a sheet form and is attached to inner side surfaces of the front sensing cover and the rear sensing cover.

8. The battery pack of claim 1, further comprising a left side end plate and a right side end plate configured to support both sides of the plurality of battery cells, respectively, wherein a height of the left side and right side end plates is lower than a height of the plurality of battery cells.

9. The battery pack of claim 1, further comprising a compression pad disposed between adjacent battery cells of the plurality of battery cells, wherein the compression pad comprises the phase-change material.

10. The battery pack of claim 9, wherein the phase-change material is coated on both side surfaces of the compression pad in contact with the battery cells.

11. The battery pack of claim 1, wherein each of the battery cells comprises:
a battery case configured to accommodate an electrode assembly;
a cell terrace extending from the battery case and configured to seal the electrode assembly; and
an electrode lead partially protruding from the cell terrace, wherein a gap filler comprising the phase-change material is applied to the cell terrace.

12. A battery pack comprising:
a battery module comprising a battery cell stack in which a plurality of battery cells are stacked in a predetermined direction;
upper and lower cooling apparatuses disposed in upper and lower portions of the battery module, respectively, the upper and lower cooling apparatuses being configured to cool heat generated from the battery module;
an upper cooling plate disposed between the battery module and the upper cooling apparatus;
a lower cooling plate disposed between the battery module and the lower cooling apparatus;
an upper gap filler filling a space between the battery cell stack and the upper cooling plate;
a lower gap filler filling a space between the battery cell stack and the lower cooling plate, wherein the upper and lower gap fillers each comprise a phase-change material;
front and rear busbar housings disposed in front and rear sides of the battery cell stack, respectively, the front and rear busbar housings being configured to electrically connect the plurality of battery cells;
front and rear sensing covers configured to cover the front and rear busbar housings, respectively;
a front gap filler and a front-and-rear gap filler filling a space between the front and rear busbar housings and the front and rear sensing covers, wherein the front gap filler and the front-and-rear gap filler each comprise the phase-change material; and
a compression pad disposed between adjacent battery cells of the plurality of battery cells, wherein the compression pad comprises the phase-change material.

13. The battery pack of claim 12, wherein the phase-change material is coated on both side surfaces of the compression pad in contact with the battery cells.

14. The battery pack of claim 12, further comprising ribs disposed in a lattice shape on inner side surfaces of the front sensing cover and the rear sensing cover, the ribs being configured to reinforce a strength of the front and rear sensing covers.

15. The battery pack of claim 14, wherein each of the ribs is filled with the front gap filler comprising the phase-change material.

16. The battery pack of claim 12, wherein the front gap filler is provided in a sheet form and is attached to inner side surfaces of the front sensing cover and the rear sensing cover.

17. The battery pack of claim 12, further comprising a left side end plate and a right side end plate configured to support both sides of the plurality of battery cells, respectively, wherein a height of the left side and right side end plates is lower than a height of the plurality of battery cells.

18. A method of forming a battery pack, the method comprising:
providing a battery module comprising a battery cell stack in which a plurality of battery cells are stacked in a predetermined direction;
disposing upper and lower cooling apparatuses in upper and lower portions of the battery module, respectively, wherein the upper and lower cooling apparatuses are for cooling heat generated from the battery module;
disposing an upper cooling plate between the battery module and the upper cooling apparatus;
disposing a lower cooling plate between the battery module and the lower cooling apparatus;
inserting an upper gap filler in a space between the battery cell stack and the upper cooling plate; and
inserting a lower gap filler in a space between the battery cell stack and the lower cooling plate, wherein the upper and lower gap fillers each comprise a phase-change material.

19. The method of claim 18, further comprising:
disposing front and rear busbar housings in front and rear sides of the battery cell stack, respectively, wherein the front and rear busbar housings are provided to electrically connect the plurality of battery cells;
providing front and rear sensing covers covering the front and rear busbar housings, respectively; and
inserting a front gap filler and a front-and-rear gap filler in spaces between the front and rear busbar housings and the front and rear sensing covers, wherein the front gap filler and the front-and-rear gap filler each comprise the phase-change material.

20. The method of claim 19, further comprising disposing a front sensing board between the front busbar housing and the battery cells, wherein a lower end portion of the front sensing board extends toward the front sensing cover to insulate between a busbar frame and the lower cooling plate.
